(19) United States
(12) Patent Application Publication
(10) Pub. No.: US 2022/0138633 A1
(43) Pub. Date: May 5, 2022

(54) METHOD AND APPARATUS FOR INCREMENTAL LEARNING

(71) Applicant: Samsung Electronics Co., Ltd., Gyeonggi-do (KR)

(72) Inventors: Yoo Jin Choi, San Diego, CA (US); Mostafa El-Khamy, San Diego, CA (US); Jungwon Lee, San Diego, CA (US)

(73) Assignee: Samsung Electronics Co., Ltd.

(21) Appl. No.: 17/317,421

(22) Filed: May 11, 2021

Related U.S. Application Data
(60) Provisional application No. 63/110,063, filed on Nov. 5, 2020.

(51) Int. Cl. G06N 20/20; G06K 9/62

(52) U.S. Cl. CPC G06N 20/20; G06K 9/628; G06K 9/6257

(57) ABSTRACT

An electronic device and method for performing class-incremental learning are provided. The method includes designating a pre-trained first model for at least one past data class as a first teacher; training a second model; designating the trained second model as a second teacher; performing dual-teacher information distillation by maximizing mutual information at intermediate layers of the first teacher and second teacher; and transferring the information to a combined student model.

### PRIORITY

This application is based on and claims priority under 35 U.S.C. § 119(e) to U.S. Provisional Patent Application Ser. No. 63/110,063, filed on Nov. 5, 2020 in the United States Patent and Trademark Office, the entire contents of which is incorporated herein by reference.

### FIELD

The present disclosure generally relates to incremental learning with dual-teacher knowledge transfer and data-free generative replay.

### BACKGROUND

Much of the natural learning process of humans is incremental, as we explore the world and observe new data over time. However, most conventional supervised learning methods do not adapt well to situations in which incremental learning is desired, since conventional supervised learning methods are developed under the assumption that all of the training data for learning is provided and used at once.

Incremental learning is a learning paradigm in which a model may acquire new knowledge from new data continually, instead of training the model with all of the data at once. A standard approach to incremental learning is to fine-tune a pre-trained model with new data when it becomes available, but sometimes fine-tuning suffers from severe performance degradation on past tasks that were already learned in the pre-trained model, which is called catastrophic forgetting. Catastrophic forgetting is caused by over-compensating based on the new data when the past data is not available and cannot be used during incremental training stages.

Therefore, an approach to generating a model capable of incremental learning that most efficiently accounts for new and old datasets is desired.

### SUMMARY

According to one embodiment, a method of performing class-incremental learning is provided. The method includes designating a pre-trained first model for at least one past data class as a first teacher; training a second model; designating the trained second model as a second teacher; performing dual-teacher information distillation by maximizing mutual information at intermediate layers of the first teacher and second teacher; and transferring the information to a combined student model.

According to one embodiment, an electronic device for performing class-incremental learning is provided. The electronic device includes a non-transitory computer readable memory and a processor, wherein the processor, upon executing instructions stored in the non-transitory computer readable memory, is configured to designate a pre-trained first model for at least one past data class as a first teacher; train a second model; designate the trained second model as a second teacher; and perform dual-teacher information distillation by maximizing mutual information at intermediate layers of the first teacher and second teacher, and transferring the information to a combined student model.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates a block diagram of zero-shot learning of a conditional generator, according to one embodiment;

FIG. 2 illustrates a block diagram using dual-teacher information distillation and data-free generative replay in a class-incremental scenario, according to one embodiment;

FIG. 3 illustrates a block diagram of dual-teacher information distillation and data-free generative replay for data-free class-incremental learning, according to one embodiment;

FIG. 4 is a flowchart illustrating a method of class-incremental learning, according to one embodiment; and

FIG. 5 is a block diagram of an electronic device in a network environment, according to one embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

The present application provides two novel knowledge data transfer techniques to improve class-incremental learning: dual-teacher information distillation and data-free generative replay.

Dual-teacher information distillation may be used to transfer knowledge from two teachers to one combined student model. In class-incremental learning, dual-teacher information distillation may be used to learn new classes incrementally based on a first model that is a pre-trained model for old classes and a second model that is trained on new data for new classes or provided as a pre-trained model. Accordingly, the expression “(pre-)trained” may refer to a model that is either trained or pre-trained.

In addition, data-free generative replay may be used to mitigate catastrophic forgetting in class-incremental learning by using synthetic samples that mimic the original training data. The synthetic samples may be produced from a generative model that is trained without using any training data. Statistics stored in batch normalization layers of the pre-trained model may be used to match characteristics of the training data.

The disclosed techniques can be used in a class-incremental learning scenario, where in each incremental learning stage, a pre-trained classification model for old classes and new training data for a set of new classes is provided.

Incremental learning involves learning new tasks incrementally, with the goal of gradually extending acquired knowledge and using it for future learning. A major challenge is to learn new tasks without catastrophic forgetting, i.e., the performance on the previously learned tasks should not significantly degrade over time as new tasks are added.

Reserving some of original training data for past tasks for future learning may reduce catastrophic forgetting; however, the effectiveness of reducing catastrophic forgetting may be limited by the number of reserved samples.

Many previous approaches of incremental learning rely heavily on extra information which should be stored and delivered along with the pretrained model for the past tasks. The burden of storing extra data for past tasks increases as more and more tasks are learned.

The present application provides an incremental learning solution that relieves the burden of storing past data or pre-trained generative models.

In class-incremental learning, a sequence of classification tasks, denoted by Tᵢ for non-negative integers i≥0, may be provided as input, where information from prior tasks may be accounted for when performing new tasks.

For example, task Tᵢ at time i may be a classification task for a set of classes Cᵢ, such that Cᵢ∪Cⱼ=ø for all i≠j, where ø denotes an empty set. At time i=0, a network task T₀ may be trained with base training set D₀. For each time i≥1, a new task Tᵢ may be provided as input and incorporated into the information learning model (e.g., the task is learned) without forgetting past tasks T₀, T₁, . . . , Tᵢ₋₁ that have already been learned. At each time i≥1, a set of new training data Dᵢ belonging to Cᵢ for Tᵢ may be provided as input. Past training data for the past tasks may not be revisited, unless a small number of samples, called exemplars, are reserved. Reserved exemplars for task i, if present, may be denoted by Rᵢ. Otherwise, if not present, reserved exemplars may be denoted as an empty set, Rᵢ=ø.

A neural network used at time i for class-incremental learning may be denoted as fᵢ. Each network fᵢ may consist of a feature extractor and a classifier that may be based on extracted features. For ease in explanation, it may be assumed that networks at different times have the same network architecture for feature extraction. However, different network architectures at different times may also be used (e.g., using a more complicated network architecture, as more classes are added). In addition, each network may have a one-layer classifier after feature extraction. For the description which follows, ϕᵢ may be the feature extractor of fᵢ and W₀ⁱ={w_{c}}_{c∈}_{₀}_{ⁱ} may be the set of classification weights used in fᵢ at time i for classification among all the learned classes C₀ⁱ=Uⱼ₌₀ⁱCⱼ, where Wᵢ={w_{c}}_{c∈C}_{ᵢ} may be the classification weights newly introduced at time i for classes Cᵢ.

The present application introduces the concept of performing information distillation using two teachers (e.g., one may be the past model pre-trained for old classes, and the other one may be the model (pre-)trained on new data for new classes) to improve the performance of class-incremental learning. This approach, referred to as dual-teacher information distillation, will now be described.

A teacher is a model that is used to train another model, referred to as a student. At time i, a first teacher may be the model fᵢ₋₁ from time i−1, which was pre-trained for old classes C₀ⁱ⁻¹. hᵢ may be a second teacher at time i, which is (pre-)trained on the new data at time i for new classes Cᵢ. A student may be the current model fᵢ that is trained at time i for both old and new classes in C₀ⁱ. For notational simplicity, t₀≡fᵢ₋₁, t₁≡hᵢ and s≡fᵢ may be used to denote the first teacher, the second teacher, and the student, respectively.

For information distillation at intermediate layers, K intermediate layers may be selected for each of the first teacher, the second teacher, and the student. In addition, intermediate layers with different resolutions may be selected (e.g., layers just before down-sampling layers may be selected). t_{0,k}, t_{1,k}, and sₖ for 1≤k≤K may be the feature maps from the k-th layer selected for dual-teacher information distillation in the first teacher, the second teacher, and the student, respectively. Dual-teacher information distillation aims to minimize information distillation losses L_{DT-ID} given by Equation (1):

L_{DT-ID}=−Σₖ₌₁^{K}(I(t_{0,k},sₖ)+I(t_{1,k},sₖ)) (1)

where I denotes mutual information. Variational information maximization may be performed with a Gaussian prior on the variational lower bound of the mutual information I, such that for each n∈{0,1}, the following relationship, given by Equation (2), is provided:

−I(t_{n,k},sₖ)≤ [symbol] [Vₖⁿ(t_{n,k},sₖ)]+X (2)

where V is given by Equation (3):

$${V}_{k}^{n} ( t , s ) = {\sum }_{c , h , w} \frac{{( {t}_{c , h , w} - {μ}_{k , c , h , w}^{n} ( s ) )}^{2}}{2 {σ}_{k , c}^{2}} + log {σ}_{k , c} \qquad ( 3 )$$

for some constant X; t_{c,h,w} is the scalar element of tensor t at channel c, height h, width w, and μ_{k,c,h,w}ⁿ(s) is the output of the neural network μₖⁿ at channel c, height h, width w, when s is provided as input; μₖⁿ is the convolutional network used to transform the student feature maps into the teacher domain at each intermediate layer k selected for information distillation. The present application provides for using a common variance σ_{k,c}² for both n∈{0,1} at each layer k and channel c, so information may be transferred from two teachers without biasing towards either of them.

Feature maps obtained from all available data Aᵢ at time i may be used to define the empirical expectation of information distillation losses L_{DT-ID} according to Equation (4):

L̅_{DT-ID}ⁱ=−Σₖ₌₁^{K} [symbol] _{(x,y)∈A}_{ᵢ}[Vₖ⁰(f_{i-1,k}(x),f_{i,k}(x))+Vₖ¹(h_{i,k}(x),f_{i,k}(x))] (4)

In addition, a data-free generative replay may also be used to mitigate catastrophic forgetting in class-incremental learning by using synthetic samples that mimic the original training data. The synthetic samples may be produced from a generative model that is trained without using any training data. The statistics stored in the batch normalization layers of the pre-trained model may be used by a generator to match features of the training data.

A pre-trained classification model, referred to as teacher t, may be provided. The teacher t may estimate the probability distribution of class y for input x. The conditional generator g may be trained to produce synthetic data similar to the training data used to train the teacher t. The conditional generator g may take a random noise vector z and a label (condition) y to produce a labeled sample, such that p(z) may refer to the random noise distribution and p(y) may refer to the label distribution over classes C. Cross-entropy loss and batch-normalization statistics loss may be employed to train the conditional generator g without any training data.

To train the conditional generator g using cross-entropy loss, the teacher t may be used as a fixed discriminator to criticize the synthetic samples from the conditional generator g. The conditional generator g may take a label y as input to synthesize labeled samples. The cross-entropy loss L_{CE} between the label fed to the generator g and the softmax output from the teacher t for the generated sample may be defined according to Equation (5):

L_{CE}(t,g)=E_{p(z)p(y)}[H(y,t(g(z,y))] (5)

where H denotes the cross-entropy and the label y may be one-hot encoded in H.

Softmax output is an expression that is known to those of ordinary skill in the art, and may be an activation function of a neural network to normalize output of a network to a probability distribution over an output class.

To train the conditional generator g using batch-normalization statistics loss, each batch normalization layer in the pre-trained teacher t may store the mean and variance of the layer input, which can be used as a proxy to verify that the generator output is similar to the original training data. A Kullback-Leibler (KL) divergence of two Gaussian distributions may be used to match statistics (e.g., the mean and variance) stored in the batch-normalization layers of the teacher t (which may be obtained when trained with the original data) and the empirical statistics obtained with the generator output.

The mean μ_{l,c} and the variance σ_{l,c}² may be stored in batch normalization layer l of the teacher t for channel c; and the mean \hat{μ}_{l,c}(g) and the variance \hat{σ}_{l,c}²(g) may be computed based on the synthetic samples produced from generator g. The batch-normalization statistics loss L_{BNS} may be defined according to Equation (6) and Equation (7):

L_{BNS}(t,g)=Σ_{l,c}D_{N}((\hat{μ}_{l,c}(g),\hat{σ}_{l,c}²(g)),(μ_{l,c},σ_{l,c}²)) (6)

where

$${D}_{N} ( ( \hat{μ} , {\hat{σ}}^{2} ) , ( μ , {σ}^{2} ) ) = \frac{{( \hat{μ} - μ )}^{2} {\hat{σ}}^{2}}{2 {σ}^{2}} - log \frac{\hat{σ}}{σ} - \frac{1}{2} \qquad ( 7 )$$

By combining the cross entropy and batch-normalization statistics losses, the losses may be minimized to perform zero-shot learning of a conditional generator, defined by

$$( {min}_{g} \{ {L}_{CE} ( t , g ) + {L}_{BNS} ( t , g ) \} ) .$$

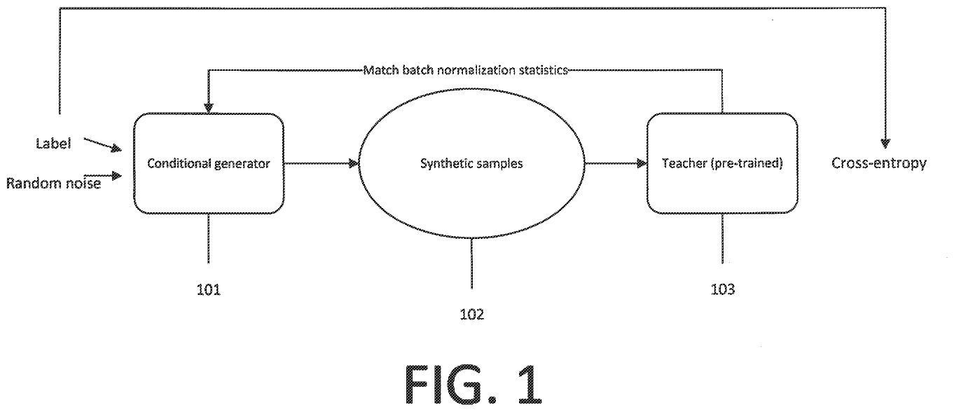

FIG. 1 illustrates a block diagram of zero-shot learning of a conditional generator, according to one embodiment.

Referring to FIG. 1, a label and random noise are provided as inputs to the conditional generator 101. The conditional generator 101 may output synthetic samples 102 to the teacher 103.

The teacher 103 may be used as a fixed discriminator to criticize the synthetic samples 102 by using cross-entropy loss and batch-normalization statistics loss, which may be combined to perform zero-shot learning of the conditional generator 101.

The dual-teacher information distillation technique and the data-free generative replay technique can be used in the class-incremental learning scenario, where in each incremental learning stage, a pre-trained classification model for old classes is provided with new training data for a set of new classes.

Data-free generative replay may be used in the class-incremental learning scenario to synthesize samples for old classes without using any past training data, and to synthesize samples for new classes without using any past training data. The synthesized samples may be used to perform incremental training to alleviate catastrophic forgetting by outputting the synthesized samples to the first teacher, the second teacher, and the student.

Dual-teacher information distillation may be applied in the class-incremental learning scenario by training the first teacher with the pre-trained model from the past and training the second teacher with new data in each incremental stage for new classes to perform a dual-teacher knowledge transfer.

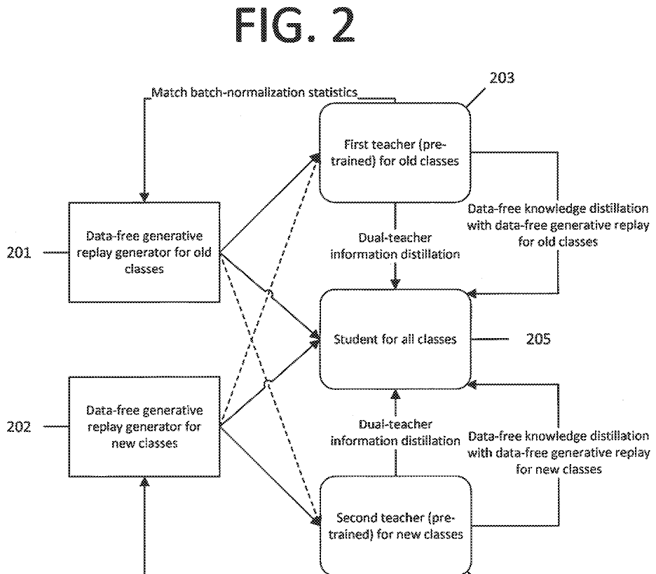

FIG. 2 illustrates a block diagram using dual-teacher information distillation and data-free generative replay in a class-incremental scenario, according to one embodiment.

Referring to FIG. 2, a data free generative replay generator (e.g., a generative model) for old classes 201 and data free generative replay generator for new classes 202 may be used to generate information (e.g., synthetic samples) for new classes and old classes, respectively.

The information for old classes may be passed to the first teacher 203, and the information for new classes may be passed to the second teacher 204. In addition, the information for old and new classes may also be output directly to the student 205. Additionally, the information for old classes may be provided to the second teacher 204, and the information for new classes may be provided to the first teacher 203.

The first teacher 203, which is pre-trained for old classes, may provide match batch-normalization statistics to the data-free generative replay generator for old classes 201, and the second teacher 204, which is pre-trained for new classes, may provide match batch-normalization statistics to the data-free generative replay generator for new classes 202.

Dual-teacher information distillation may be used to provide information from the second teacher 204 to the student for all classes 205, and from the first teacher 203 to the student for all classes 205. That is, data-free knowledge distillation may be applied with data-free generative replay to provide information for new classes from the second teacher 204 to the student 205, and to provide information for old classes from the first teacher 203 to the student 205.

To perform data-free generative replay at time i for a class-incremental learning scenario, a pre-trained model fᵢ₋₁ for old classes from time i−1 may be set to be the first teacher. For each time i, a new generator gᵢ may be trained from scratch based on the previous model fᵢ₋₁ without using any training data. Accordingly, no pre-trained generators need to be provided and used in future iterations.

The synthetic samples from gᵢ may be used for class-incremental learning by including them when computing the dual-teacher information distillation losses by adding the synthetic samples to the available data Aᵢ. Also, data-free knowledge distillation loss for synthetic samples of old classes, which is defined as the cross-entropy between the softmax outputs of the past model fᵢ₋₁ and the current model fᵢ may also be added to the data Aᵢ.

The past model fᵢ₋₁ may only yield the probability (softmax output) for old classes, while the current model fᵢ, trained at time i, may be used to produce the probability for both old and new classes. For knowledge distillation from fᵢ₋₁ to fᵢ, the number of classes should be matched (e.g., the classification layer of fᵢ₋₁ should be extended to cover the new classes). This may be accomplished by weight imprinting.

To perform weight imprinting, the feature extractor output may be collected for every training sample of each new class and may use their average as the classification weight of that class. If a cosine-similarity-based classifier is used, then the features may be normalized before taking their average. The imprinted weight w_{c} may be defined according to Equation (8):

$${w}_{c} = {𝔼}_{( x , y ) ∈ {D}_{i} ( c )} [ \frac{{ϕ}_{i - 1} ( x )}{\vert {ϕ}_{i - 1} ( x ) \vert} ] , c ∈ {C}_{i} \qquad ( 8 )$$

where Dᵢ(c) is the samples of class c∈Cᵢ in Dᵢ.

Accordingly, weight imprinting may be used to find the weight that maximizes the average cosine similarity to the features extracted from the available training samples for each class.

As discussed below, data-free knowledge distillation may be used to train a new model based on a pre-trained model when, for instance, sharing original training data is restricted due to privacy and licensing issues.

If \hat{f}ᵢ₋₁ is the past model having an extended classifier with weight imprinting for new classes, then the data-free knowledge distillation loss L_{DF-KD} may be defined according to Equation (9):

L_{DF-KD}=E_{p(z)p}_{ᵢ}_{(y)}[H(\hat{f}ᵢ₋₁(gᵢ(z,y)),fᵢ(gᵢ(z,y)))] (9)

where pᵢ(y) is the label distribution, for which the uniform distribution over all the past classes C₀ⁱ⁻¹ at time i is used.

As discussed above, data-free generative replay may be applied to an incremental class learning scenario to generate synthesized samples for old classes without using any past training data. However, the second teacher, in the aforementioned scenario, relies on new data to incrementally train a model to perform dual-teacher information distillation, and new training data may not always be easily accessible due to, for example, memory size, proprietary rights, and/or to preserve privacy.

Thus, the present application provides an approach of data-free class-incremental learning for when new training data is not available by combining two pre-trained models for old and new classes into one fused model that can perform classification on all the old and new classes. In this scenario, original training data and new training data are not provided; thus, the approach is data-free.

This approach does not require any past data or pre-trained generative models to be stored because a generative model may be trained from scratch, without using any past training data, given a pre-trained past model. Accordingly, the generative model for past tasks may be trained by the current model trainer, which may be adapted for a new task, without accessing any previous data.

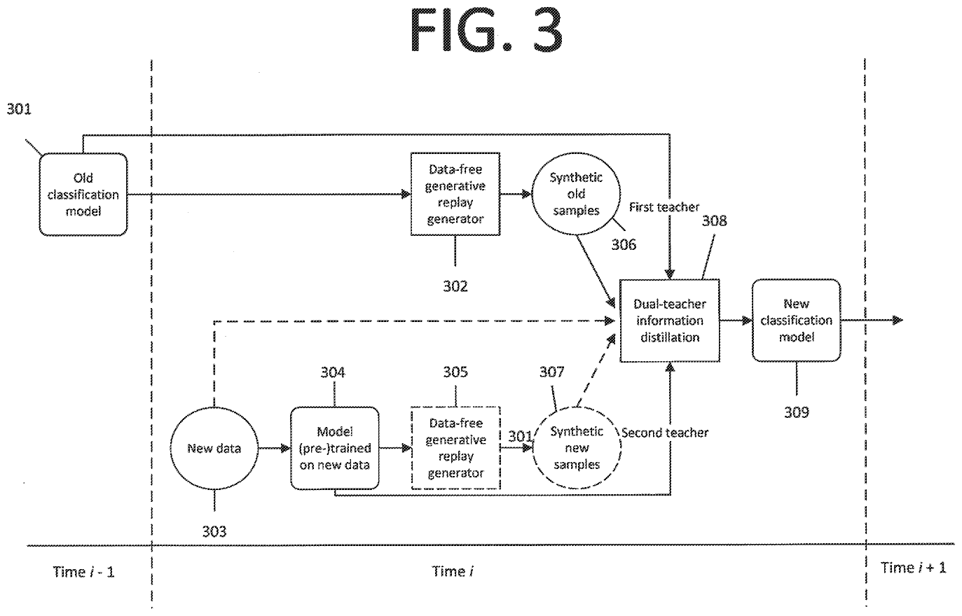

FIG. 3 illustrates a block diagram of dual-teacher information distillation and data-free generative replay for data-free class-incremental learning, according to one embodiment.

Referring to FIG. 3, two generative models for data-free generative replay may be trained based on two pre-trained teacher models. That is, an old classification model 301 (e.g., a model that was trained based on data from at least one old class) may be used to train data-free generative replay generator 302, and a model 304 that is (pre-)trained for new classes may be used to train data-free generative replay generator 305.

Data-free generative replay generator 302 and data-free generative replay generator 305 may respectively generate synthetic old samples 306 (based on old classes) and synthetic new samples 307 (based on new classes), which may be used for dual-teacher information distillation 308 to transfer knowledge from two teachers to one fused new classification model 309. Although model 304 may be provided as a (pre-)trained teacher model, it is also possible to use at least some new data 303 to aid in training model 304. In addition, some new data 303 may also optionally be provided as input to dual-teacher information distillation 308 to generate a new classification model 309.

The synthetics samples 306 and 307 from the two generators 302 and 305 may be combined when computing the dual-teacher information distillation loss, as in the single data-free generative replay case. Since two generators 302 and 305 are provided, two data-free knowledge distillation losses may occur. If weight imprinting information is provided, then the data-free knowledge distillation losses may be determined based on Equation (9), above.

Alternatively, when weight imprinting information cannot be accessed, a “none” class may be used to pre-train two teachers in order to utilize Equation (9), above. If a “none” class is already included in each of Cₜ and Cₛ, H(t,ŝ) may be used for the data-free knowledge distillation loss between t and s, where ŝ={ŝ_{c}}_{c∈C}_{ₜ} and an input x may be omitted when, for example, two teachers have been pre-trained with the extra “none” class. That is, for the input x, where t(x)={t_{c}(x)}_{c∈C}_{ₜ} and s(x)={s_{c}(x)}_{c∈C}_{ₛ} are the teacher and student softmax outputs for classes Cₜ and Cₛ, respectively, where Cₜ ⊂Cₛ, using the “none” class, ŝ may be defined according to Equation (10):

$$\hat{s} = \{ \begin{matrix}{s}_{c} , & c ∈ {C}_{t} \backslash \{ none \} , \\ {\sum }_{{c}^{′} ∈ ( {C}_{s} \backslash {C}_{t} ) ⋃ \{ none \}} {s}_{{c}^{′}} , & c = none\end{matrix} . \qquad ( 10 )$$

Thus, in a data-free class-incremental learning scenario, two teachers may be pre-trained based on the extra “none” class.

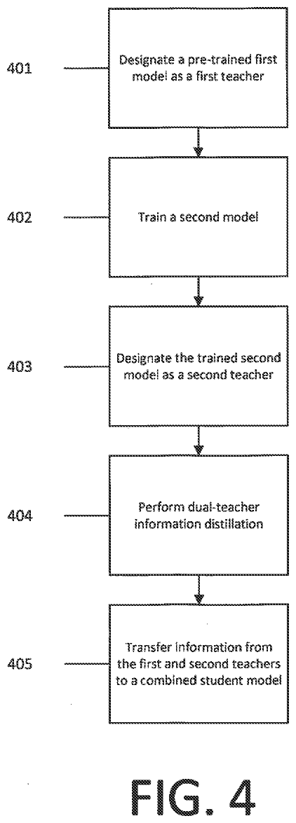

FIG. 4 is a flowchart illustrating a method of class-incremental learning, according to one embodiment.

Referring to FIG. 4, in step 401, a pre-trained first model is designated as a first teacher. The pre-trained first model may be provided in an already-trained state. Alternatively, the pre-trained first model may be trained based on training data. The training data may be for an old class in a past time.

In step 402, a second model is trained. The second model may be trained with or without data. For example, if the second model is trained without data, then data-free generative replay may be used to train the second model. Alternatively, data-free generative replay may be used to train the second model even when some data is provided. That is, data-free generative replay may be used to generate synthesized samples, in the manner described above, and a small amount of data (e.g., an amount of data that is less than an entire class) may be provided as input. By using a small amount of data and the synthesized samples, the second model can be trained quickly and efficiently.

In step 403, the trained second model is designated as a second teacher. In step 404, dual-teacher information distillation is performed. Dual-teacher information distillation may include maximizing mutual information at intermediate layers of the first teacher and the second teacher to be transferred to the student model.

In step 405, information is transferred from the first teacher and the second teacher to the student model.

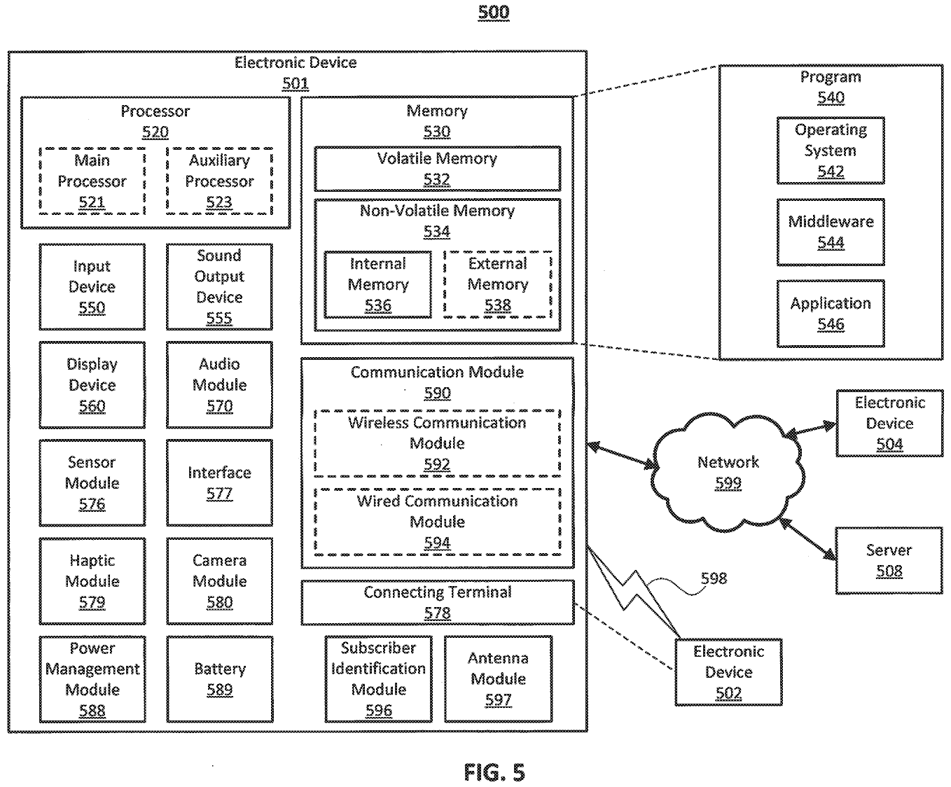

FIG. 5 is a block diagram of an electronic device 501 in a network environment 500, according to one embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute, for example, software (e.g., a program 540) to control at least one other component (e.g., a hardware or a software component) of the electronic device 501 coupled with the processor 520, and may perform various data processing or computations. As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550, or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes.

The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as Bluetooth™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

One embodiment may be implemented as software (e.g., the program 540) including one or more instructions that are stored in a storage medium (e.g., internal memory 536 or external memory 538) that is readable by a machine (e.g., the electronic device 501). For example, a processor of the electronic device 501 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Accordingly, the present application provides a novel approach to account for less-forget losses, cross entropy losses, batch-normalization losses, and dual-teacher information distillation losses.

By applying dual teacher knowledge transfer, data free generative replay, or both, the present application provides a manner in which each of the aforementioned losses may be accounted for in a class-incremental learning scenario, even when no training data is available. This approach advantageously reduces the amount of memory required and increases the processing speed of performing class-incremental learning.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method of performing class-incremental learning, the method comprising:
designating a pre-trained first model for at least one past data class as a first teacher;
training a second model;
designating the trained second model as a second teacher;
performing dual-teacher information distillation by maximizing mutual information at intermediate layers of the first teacher and second teacher; and
transferring the information to a combined student model.

2. The method of claim 1, further comprising:
training at least one of a first conditional generator or a second conditional generator to generate synthetic data, given the first model or the second model, without using any stored training data,
wherein the synthetic data is configured to mimic training data used to train the first teacher or the second teacher.

3. The method of claim 2, further comprising:
determining a cross-entropy loss between a label input into the conditional generator and a value output from the first teacher or the second teacher;
determining a batch-normalization statistics loss by matching mean and variance variables stored in batch-normalization layers of the first teacher or the second teacher with mean and variance variables computed at the same batch-normalization layers of the first teacher or the second teacher for information output from the conditional generator; and
incrementally adjusting the conditional generator to account for the cross-entropy loss and the batch-normalization statistics loss.

4. The method of claim 1, wherein the first model designated as the first teacher is updated using weight imprinting by accessing stored training data.

5. The method of claim 1, wherein the trained second model designated as the second teacher is trained by using a “none” class in response to training data not being accessible.

6. The method of claim 1, wherein performing the dual-teacher information distillation further comprises:
applying data-free generative replay to generate a first set of synthetic samples with a first conditional generator for a first class at a first time;
applying data-free generative replay to generate a second set of synthetic samples with a second conditional generator for a second class at a second time, wherein the second time is after the first time;
determining a dual-teacher information distillation loss based on the first set of synthetic samples and the second set of synthetic samples; and
accounting for the dual-teacher information distillation loss when performing dual-teacher information distillation.

7. The method of claim 2, wherein training the first conditional generator or the second conditional generator further comprises using a pre-trained model to generate the synthetic data that is used to train the first conditional generator or the second conditional generator without using any stored training data.

8. The method of claim 1, wherein the second model designated as the second teacher is trained with new data for each new class that is introduced.

9. The method of claim 1, wherein data output from the second teacher and data output from the first teacher are applied to the combined student model to perform dual-teacher information distillation.

10. An electronic device for performing class-incremental learning, the electronic device comprising a non-transitory computer readable memory and a processor, wherein the processor, upon executing instructions stored in the non-transitory computer readable memory, is configured to:
designate a pre-trained first model for at least one past data class as a first teacher;
train a second model;
designate the trained second model as a second teacher;
perform dual-teacher information distillation by maximizing mutual information at intermediate layers of the first teacher and second teacher; and
transferring the information to a combined student model.

11. The electronic device of claim 10, wherein the processor, upon executing the instructions stored in the non-transitory computer readable memory, is further configured to:
train at least one of with a first conditional generator or a second conditional generator to generate synthetic data, given the first model or the second model, without using any stored training data,
wherein the synthetic data is configured to mimic training data used to train the first teacher or the second teacher.

12. The electronic device of claim 11, wherein the processor, upon executing the instructions stored in the non-transitory computer readable memory, is further configured to:
determine a cross-entropy loss between a label input into the conditional generator and a value output from the first teacher or the second teacher;
determine a batch-normalization statistics loss by matching mean and variance variables stored in batch-normalization layers of the first teacher or the second teacher with mean and variance variables computed at the same batch-normalization layers of the first teacher or the second teacher for information output from the conditional generator; and
incrementally adjust the conditional generator to account for the cross-entropy loss and the batch-normalization statistics loss.

13. The electronic device of claim 10, wherein the first model designated as the first teacher is updated using weight imprinting by accessing stored training data.

14. The electronic device of claim 10, wherein the trained second model designated as the second teacher is trained by using a “none” class in response to training data not being accessible.

15. The electronic device of claim 10, wherein performing the dual-teacher information distillation further comprises:
applying data-free generative replay to generate a first set of synthetic samples with a first conditional generator for a first class at a first time;
applying data-free generative replay to generate a second set of synthetic samples with a second conditional generator for a second class at a second time, wherein the second time is after the first time;
determining a dual-teacher information distillation loss based on the first set of synthetic samples and the second set of synthetic samples; and
accounting for the dual-teacher information distillation loss when performing dual-teacher information distillation.

16. The electronic device of claim 11, wherein training the first conditional generator or the second conditional generator further comprises using a pre-trained model to generate the synthetic data that is used to train the first conditional generator or the second conditional generator without using any stored training data.

17. The electronic device of claim 10, wherein the second teacher is trained with new data for each new class that is introduced.

18. The electronic device of claim 10, wherein data output from the second teacher and data output from the pre-trained first teacher are applied to the combined student model to perform dual-teacher information distillation.
